(19) United States
(12) Patent Application Publication
(10) Pub. No.: US 2016/0284154 A1
(43) Pub. Date: Sep. 29, 2016

(54) EFFICIENT PARKING METER ENFORCEMENT SYSTEM AND METHOD

(71) Applicant: Steven SCHRAGA, Surfside, FL (US)

(72) Inventor: Steven SCHRAGA, Surfside, FL (US)

(21) Appl. No.: 14/414,717

(22) PCT Filed: Sep. 16, 2014
(86) PCT No.: PCT/US14/55785

§ 371 Date: Jan. 14, 2015

Related U.S. Application Data
(60) Provisional application No. 61/878,905, filed on Sep. 17, 2013.

(51) Int. Cl. G07F 17/24

(52) U.S. Cl. CPC G07F 17/246; G06Q 2240/00

(57) ABSTRACT

Parking enforcement system and method includes plural information input units structured and arranged to receive vehicle identification information. An information collection unit collects, stores and/or receives information from the plural information input units. At least one deployable unit is structured and arranged to read or obtain vehicle identification information directly from one or more vehicles located in designated parking locations and determine whether a respective vehicle is authorized to be parked in one of the designated parking locations.

### CROSS-REFERENCE TO RELATED APPLICATIONS

The instant application is an International Application that is based on and claims the benefit of U.S. provisional application No. 61/878,905 filed on Sep. 17, 2013, the disclosure of which is hereby expressly incorporated by reference thereto in its entirety.

### BACKGROUND OF THE INVENTION

1. Field of the Invention

The present invention generally relates to a vehicle parking enforcement system and method of implementing the same.

2. Discussion of Background Information

Parking enforcement and electronic parking meters are now well known and used widely. US 2003/0132840 to BAHAR, the disclosure of which is incorporated by reference in its entirety, discloses an enhanced parking meter system utilizing user identification technology to achieve improved efficiencies in the enforcement and regulation of parking meters. A user and/or vehicle is identified by communication of user data into the parking meter system. If the meter becomes expired with the vehicle remaining in the parking space, a citation will be electronically processed, in accordance with the user data, and thereafter delivered to the user or vehicle owner. Recognition of the user and/or vehicle further enables the system to limit the individual's and/or vehicle's parking time in front of a particular meter or designated cluster of meter. This would help regulate traffic within a municipality district as well as prevent people from parking in a metered location for excessive periods of time

US 2005/0068196 to MARIN, the disclosure of which is incorporated by reference in its entirety, discloses a system for automatically enforcing parking spaces. The system comprises a vehicle sensor for determining whether a vehicle is parked in the parking spaces and a vehicle identification device for capturing images of the vehicle. The system further comprises a parking meter. The parking meter comprises a processor, a memory, a file storage unit comprising a violation manager for determining whether a violation has occurred and generating a notice of violation, and a communications unit for transmitting the notice, and the images or unique characteristics of the vehicle, via a network to a central receiving office, wherein the central receiving office identifies the owner of the vehicle and creates a summons for the owner of the vehicle in response to the notice of violation

US 2012/0158466 to JOHN, the disclosure of which is incorporated by reference in its entirety, relates to parking meters, and in particular, to an automated parking meter that recognizes a parker by reading an identification card, such as a car registration, insurance card, license, etc., and is configured to visually display the current status of the vehicle and so that in the event that the meter expires or payment is not made, a ticket can be generated and delivered to the parker

U.S. Pat. No. 7,393,134 to MITSCHELE, the disclosure of which is incorporated by reference in its entirety, relates to a parking meter that includes a microcontroller and a timer coupled with a microcontroller. A mechanism for accepting payment by coin, credit card or both is coupled with the microcontroller for accepting payment for use of an associated parking space. The microcontroller initiates the timer for a prepaid parking interval upon receiving a signal from the payment acceptance mechanism. A vehicle detector is coupled with the microcontroller for detecting the presence or absence of a vehicle in the associated parking space. The microcontroller initiates an interrogation station to direct an interrogation signal at the associated parking space in the area of the parking space where the license plate of a parked vehicle is located upon determining the existence of a parking violation.

While advances have been made in improving or making parking enforcement more efficient, there is a continuing need for more efficient parking enforcement which provides additional advantages relating to ease of use, safety, reliability and accuracy.

### SUMMARY OF THE INVENTION

According to one non-limiting embodiment of the invention, there is provided a parking enforcement system comprising plural information input units structured and arranged to receive vehicle identification information, an information collection unit collecting information from the plural information input units, and at least one deployable unit structured and arranged to read or obtain vehicle identification information from vehicles located in designated parking locations and determine whether a respective vehicle is authorized to be parked in one of the designated parking locations.

The at least one deployable unit may be structured and arranged to read in real time the vehicle identification information from vehicles located in designated parking locations.

The at least one deployable unit may be structured and arranged to obtain in real time the vehicle identification information from vehicles located in designated parking locations.

The at least one deployable unit may be structured and arranged to determine in real time whether a respective vehicle is authorized to be parked in one of the designated parking locations.

The plural information input units may be parking meters.

The plural information input units are municipal parking meters.

The information received by the plural information input units includes optically readable vehicle information.

The vehicle identification information includes license place information or vehicle VIN information.

The vehicle identification information is input by a driver of one of the vehicles wishing to park the vehicle in one of the designated parking locations.

The vehicle identification information is input by a driver of one of the vehicles wishing to park the vehicle in one of the designated parking locations inserting at least one readable device into one of the plural information input units.

The at least one readable device comprises one of a credit card, a smart card, a driver's license, an insurance card, and a display device displaying one of the above-noted items.

The vehicle identification information is electronically received from at least one readable device via one of the plural information input units.

The vehicle identification information is obtained from at least one of the vehicle automatically.

The vehicle identification information is obtained from at least one of the vehicles wirelessly via at least one of the plural information input units.

The at least one deployable unit comprises a license plate reader which automatically reads the license plate information of vehicles located in designated parking locations, compares the license plate information to the information provided by or residing in the information collection unit, and determines whether a respective vehicle is authorized to be parked in one of the designated parking locations.

The at least one deployable unit comprises a license plate reader which automatically reads the license plate information of vehicles located in designated parking locations and determines in real time whether a respective vehicle is authorized to be parked in one of the designated parking locations. In embodiments, the designated parking locations are located and/or are associated with a parking lot.

The at least one deployable unit comprises a vehicle identification reader which automatically reads vehicle identification information of vehicles located in designated parking locations, determines in real time whether a respective vehicle is authorized to be parked in one of the designated parking locations, and, if not, issues a warning or indication that the vehicle is not authorized to be parked in one of the designated parking locations. In embodiments, the designated parking locations are located and/or are associated with a parking lot.

The at least one deployable unit is arranged on a vehicle designated to undertake parking enforcement.

The at least one deployable unit is a portable unit adapted to be transported by a parking enforcement officer.

The information collection unit is arranged in or on a main component also containing the at least one deployable unit.

According to another non-limiting embodiment, there is provided a parking enforcement system comprising plural information input units structured and arranged to receive vehicle identification information and located in areas proximate to designated parking locations, an information collection unit collecting information from the plural information input units, and at least one deployable unit structured and arranged to each of: receive in real time the collected information; read or obtain vehicle identification information in real time from vehicles located in designated parking locations, and determine in real time whether a respective vehicle is authorized to be parked in one of the designated parking locations. In embodiments, the designated parking locations are located and/or are associated with a parking lot.

According to another non-limiting embodiment, there is provided a method of parking enforcement comprising receiving in real time vehicle information from vehicles authorized to be parked in designated parking locations, reading or obtaining vehicle identification information in real time from vehicles located in designated parking locations, and determining in real time whether a respective vehicle is authorized to be parked in one of the designated parking locations.

According to another non-limiting embodiment, there is provided a method of parking enforcement comprising receiving vehicle information from all vehicles authorized to be parked in designated parking locations of a predetermined or designated area or zone, reading or obtaining vehicle identification information, via a transportable reader unit, from vehicles located in the designated parking locations, producing an audible or visual indication recognizable by a user transporting the transportable reader unit when a respective vehicle is determined to not be authorized to be parked in one of the designated parking locations, and at least one of: issuing a ticket or citation to the vehicle determined to not be authorized to be parked in one of the designated parking locations; disabling or rendering immovable the vehicle determined to not be authorized to be parked in one of the designated parking locations; and towing away the vehicle determined to not be authorized to be parked in one of the designated parking locations.

According to another non-limiting embodiment, there is provided a parking enforcement system comprising plural information input units structured and arranged to receive information usable to identify a vehicle and a comparing device comparing vehicle information obtained from vehicles located in designated parking locations to the information received by one or more of the plural information input units.

According to another non-limiting embodiment, there is provided a parking enforcement system comprising at least one information input unit structured and arranged to receive information usable to identify a vehicle and a comparing device comparing vehicle information obtained from vehicles located in designated parking locations to the information received by the at least one information input unit.

In embodiments, the at least one information input unit is one of a computer, a desktop computer, a smart held-held device and a tablet computer.

In embodiments, the system may further comprise a deployable unit which reads vehicle information and records a location of the read vehicle and a time of recording of the vehicle information.

According to another non-limiting embodiment, there is provided a parking enforcement system comprising at least one vehicle information reader structured and arranged to read vehicle information that includes vehicle identification information, vehicle location, and time the vehicle is read and a comparing device comparing the vehicle information read at one point in time with the vehicle information read at another point in time.

In embodiments, the vehicle information reader and the comparing device are arranged on a deployable unit.

According to another non-limiting embodiment, there is provided a parking enforcement system comprising at least one visual information receiving unit structured and arranged to receive visual information associated with at least one of a vehicle located in a specific area and a parking location located in the specific area. A determining device determines at least one of whether the vehicle located in a specific area is authorized to be in the specific area at a predetermined future point in time, and/or whether the parking location located in the specific area is occupied by a vehicle when the parking location should no longer be occupied. The at least one visual information receiving unit is coupled to or communicates with the determining device.

In embodiments, the at least one visual information receiving unit is a camera.

In embodiments, the determining device is a portable electronic device comprising a display.

In embodiments, the determining device is a computer comprising a display.

According to another non-limiting embodiment, there is provided a parking enforcement system comprising at least one visual information receiving unit structured and arranged to receive visual information associated with at least one of a vehicle located in a specific area and a parking location located in the specific area. A control determines whether the vehicle located in a specific area has obtained authorization to be in the specific area; and if not, whether the parking location located in the specific area is occupied by the unauthorized vehicle for more than a predetermined minimum amount of time such as one minute, and if so, issuing a notice to requiring payment for parking in the vehicle in the parking location.

In embodiments, the issuing comprises either providing electronic notification or mailing the notice to an address associated with the vehicle such as is obtained by reading the license plate thereof.

In embodiments, the issuing comprises automatically issuing either providing electronic notification or mailing the notice to an address associated with the vehicle such as is obtained by reading the license plate thereof.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a first non-limiting embodiment of a parking enforcement system in accordance with the invention;

FIG. 2 shows a non-limiting embodiment of an information input unit or meter hat can be utilized in the system in accordance with the invention;

FIG. 3 shows a non-limiting embodiment of an information collection unit that can be utilized in the system in accordance with the invention;

FIG. 4 shows a non-limiting embodiment of a deployable unit that can be utilized in the system in accordance with the invention;

FIG. 5 shows a non-limiting embodiment of a designated parking area located on a street having opposite sides which opposite flows of traffic. The designated parking locations are labeled A-F with a vehicle already shown parked in location C. The parking locations A-F are supervised by one or more meters M—two of which are shown;

FIG. 6 shows a non-limiting embodiment of a designated parking area located in a parking lot. The designated parking locations are labeled A-L;

FIG. 7 shows a second non-limiting embodiment of a parking enforcement system in accordance with the invention; and

FIG. 8 shows a third non-limiting embodiment of a parking enforcement system in accordance with the invention.

### DETAILED DESCRIPTION OF THE INVENTION

In embodiment of the invention, there is provided a parking enforcement system comprising plural information input units structured and arranged to receive vehicle identification information, an information collection unit collecting information from the plural information input units, and at least one deployable unit structured and arranged to read or obtain vehicle identification information from vehicles located in designated parking locations and determine whether a respective vehicle is authorized to be parked in one of the designated parking locations.

Each input information unit can be a parking meter type device which allows a vehicle driver to input vehicle information, allows the driver to obtain authorization to park the vehicle in one of the designated parking location by, e.g., making payment for a designated amount of parking time, and/or provides the driver with evidence of such authorization, e.g., a receipt or ticket.

The information collection unit collecting information from the plural information input units can be a central computer, a computer server, a network main computer, can also be part of a cloud based system, and/or can even be located in one or more of the deployable units. In embodiments, this unit collects real time information from all vehicles which have received authorization to be parked in the designated locations and is updated continuously or in real time as to the real state of all authorized vehicles.

In the case of an authorized vehicle exceeding the time paid form, for example, either the information input unit that received that vehicle's information or the information collection unit (which is made aware of the amount of time paid for as well as the current time) can change the status of this vehicle to unauthorized and can inform the at least one deployable unit of this status change—such that if this vehicle has its information read by one of more of the deployable units, it will issue a signal, e.g., audible or visual, indicating that this vehicle is an unauthorized vehicle. The vehicle can then be ticketed, towed away, and/or disabled, e.g., booted.

In the case of an unauthorized vehicle being parked in one of the designated parking locations, for example, the driver who parked the vehicle there without any intention to pay for parking time (or did so without knowing that he/she was required to pay for parking time), because the information collection unit (which is made aware of all authorized vehicles in a designated area or zone) contains the vehicle information for all authorized vehicles, when this vehicle has its information read by one of more of the deployable units, it will issue or result in the issuance of a signal (after comparing the vehicle information to that the information received from the information collection unit), e.g., audible, visual, or other sensory signaling, indicating that this vehicle is an unauthorized vehicle. The vehicle can then be ticketed, towed away or disabled, e.g., booted. Alternatively, it will issue a signal after the deployable unit sends the vehicle information to the information collection unit and receives back a signal indicative of the vehicle being unauthorized, e.g., audible, visual, etc., indicating that this vehicle is an unauthorized vehicle. The vehicle can then be ticketed, towed away or disabled, e.g., booted.

In embodiments, the at least one deployable unit can include a license plate reader arranged on a parking enforcement vehicle or be on a portable device on the officer's person. The unit can also preferably contain hardware/software that uses the vehicle identification information from vehicles located in designated parking locations, compares this information in real time to information (or list) of all authorized vehicles, and, based on the comparing, determines whether a respective vehicle is authorized to be parked in one of the designated parking locations. In this way, a parking enforcement officer driving around a designated zone containing designated parking locations has available to him/her a system which reads the license plates of parked vehicles, checks to see if they are legally parked, and automatically flags those vehicles that are not or no longer legally parked—all without getting out of the vehicle. If the officer is on foot, a portable device containing the license plate reader and receiving vehicle information from all currently authorized vehicles will allow the officer to flag unauthorized vehicles within a second or two of the officer aiming the license plate reader onto the license plate of each parked vehicle.

In embodiments, in the case of a parking lot with multiple designated parking locations, if a driver parks in any one of the locations but has paid for the time located in the lot, moving from one location in the lot to another location in the same lot need not trigger a fine or ticket or otherwise cause this vehicle to be flagged. The system need to not flat this vehicle since it is authorized to be the lot.

While present invention relates to an enhanced parking meter system utilizing user identification technology to achieve improved efficiencies in the enforcement and regulation of parking meters and utilizes the term “vehicle” to generally denote reference to an automobile, the invention is also applicable to motorcycles, trucks, bicycles, golf carts, or other types of transportation devices whether human controlled/driven or even of the self-driving type. Additionally, the term “user”, as used herein and in the claims, refers to any individual who has or is using a parking meter and/or who is the owner or is otherwise properly or legally authorized to use the vehicle. It is also noteworthy that various functional elements for the enhanced parking meter system disclosed below may comprise an independent enhancement unit that can be installed onto an existing mechanical or electronic parking meter. Alternatively, the elements may be manufactured into a new and intact parking meter unit(s). Either way, however, the enhanced parking meter system of this present invention may be utilized by both public and/or private entities to achieve desired parking efficiencies. Given this, it is further notable that while a parking citation is generally issued by a government entity (e.g. municipality), it may likewise be issued by a private entity. Both may independently determine the fine amount and issuance guidelines that would best accord to their intended use of the enhanced parking meter system.

It is noteworthy that user data as described herein may include, but is not limited to the name, address, telephone number, fax number, e-mail address, drivers license number, social security number, fingerprint impression, DNA code, biometrics, sex, age, and other particulars that can personally identify the user and/or vehicle utilized by the user. Additionally, user data may further include data that identifies the vehicle driven by the user, such as the vehicle license plate number, VIN number, registration particulars, vehicle make, model, year, color, etc. Third, user data may include data pertaining to a personal or company financial account (e.g. a bank account, credit card account, or debit account) that is related to the user. Furthermore, data containing history of the vehicle driven by the user or of the user themselves such as medical condition(s), criminal record(s)/conviction(s), parking permits and similar type unpaid or paid for parking exemptions (e.g. restricted district parking permit which includes data such as permit number, validity status, period of validity, etc.), current and past job description, and recreation particulars (e.g. shopping activities, sports activities, hobbies, likes, dislikes, etc.) may likewise qualify as user data. While various types of user data (as mentioned above) may identify a user, that which uniquely pertains to the user (i.e. driver's license number, social security number, fingerprint impression, etc.) is of particular significance. This is because such data offers the most precise and accurate method of identifying the user. Data pertaining to the parking violation, on the other hand, may include, but is not limited to time, date, and location of the violation. Additionally data describing the nature of the parking violation may further qualify. This includes, but is not limited to expiration of the parking meter resulting from failure to purchase allowable parking time, expiration of the parking meter after the maximum allowable parking time limit for a user has been reached, and unauthorized parking during a restricted time or date.

The user data can be contained on a variety of elements that are capable of storing data and communicating it to and from the parking meter. One type of an identification element is readable cards such as those equipped with a magnetic strip or electronic “smart” chip (i.e. smart cards). For example, a pre-paid parking card, credit/debit card, or driver's license can be programmed with the user data, especially at the time it is issued. Additionally, electronically operated devices capable of communicating data to and from the parking meter or its integrated network are further contemplated. These identification elements may utilize either wired or preferably, wireless technology (e.g. radio frequency, infrared transmission) for communication of data. Furthermore, they may either be hand held and/or resident on the user's vehicle. For example, a mobile transmitter, cellular telephone, or hand-held PC may utilize radio frequency technology to establish a communication link with the meter. User data resident on either the transmitter, cellular phone, or hand-held PC may thereafter be sent to and stored by the meter or its integrated network. In one scenario, a radio frequency transmitter (e.g. resident in the user's vehicle) may automatically establish a communication link with the meter when it comes within a certain distance to the meter. Thereafter, the user data which is stored in the transmitter may be automatically communicated to the meter. It is noteworthy that while communication of the user data to the meter will generally require user interaction with the meter, it may also be done automatically (without the user's interaction) by the identification element (as is the case in the example above).

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachers herein, one of ordinary skill in the related art will be able to contemplate these and similar implementations of the present invention.

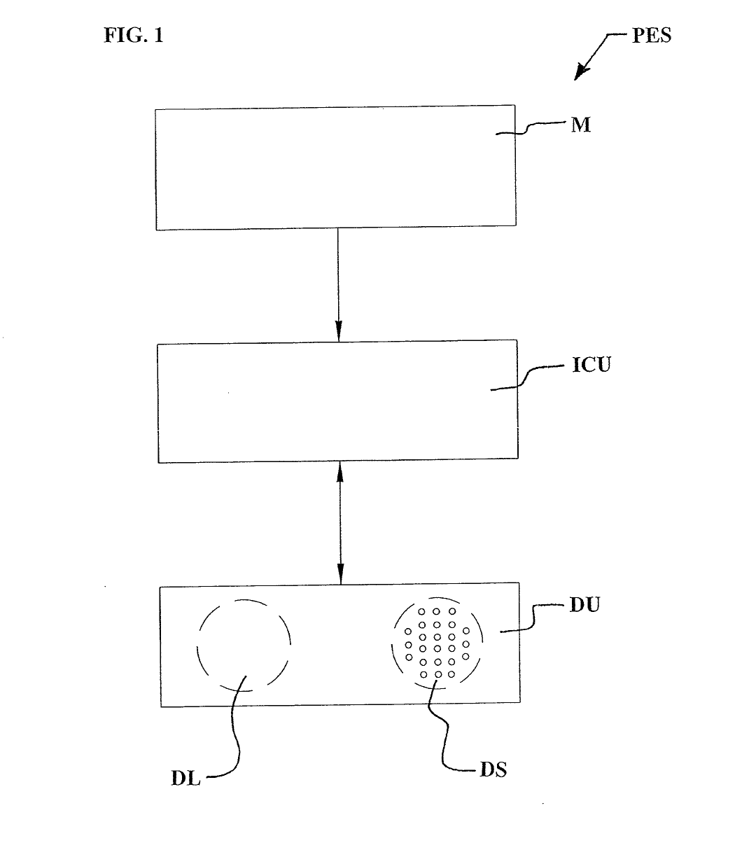

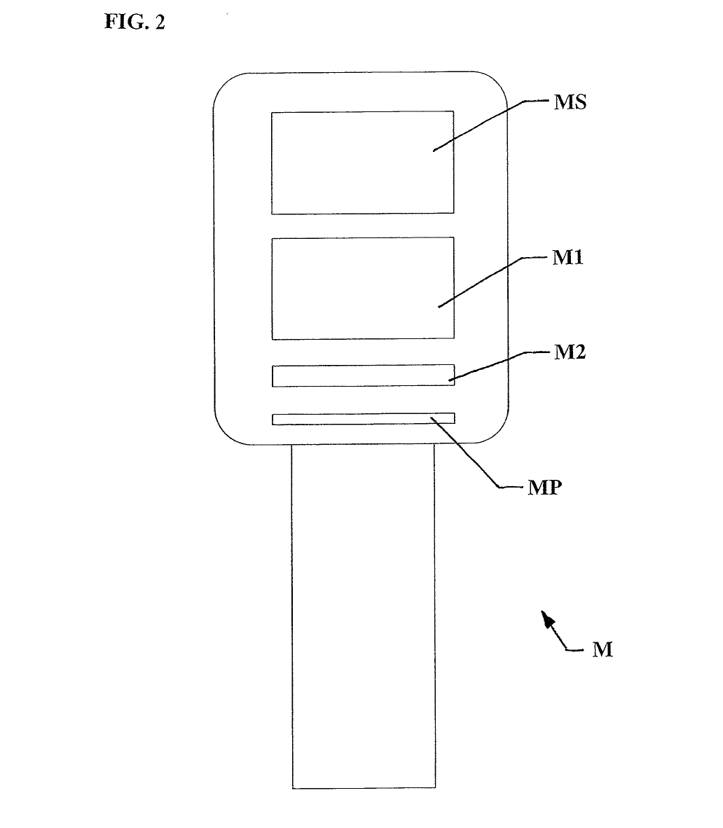

FIG. 1 shows a first non-limiting embodiment of a parking enforcement system PES in accordance with the invention. The system PES includes one or more information input units M that are structured and arranged to receive vehicle identification information. These units M can have the form of a parking meter or smart parking meter. The vehicle information can be of any type such as license plate and/or Vehicle Identification Number (VIN) information. In embodiments, the meter M can include features such as shown in FIG. 2 which will be described in detail later on. The system PES also includes an information collection unit ICU which collects information from the plural information input units. The arrow from the unit(s) M to unit ICU is intended to show that information from the unit(s) M can be transmitted or otherwise sent electronically to the unit ICU. This can occur directly or via a connection or information transfer arrangement via a cloud. The system also includes at least one deployable unit DU structured and arranged to read or obtain vehicle identification information from vehicles V located in designated parking locations and determine whether a respective vehicle is authorized to be parked in one of the designated parking locations. Since the unit ICU is made aware of all vehicles in designated parking spaces by the unit(s) M, any vehicle V which has its information read by the unit DU can be compared to those stored or otherwise maintained in the unit ICU (or cloud) to determine if the read vehicle is properly parked. If not, the unit DU can provide an indication, e.g., an audible indication via a speaker DS or a visual indication via a light DL. This alert can allow the person having the unit DU to know that there is an improperly parked vehicle so that he/she can issue a ticket or other indicia of violation. In this embodiment, it is contemplated that the unit DU will be able to read vehicle information automatically or in real time as the officer (or other authorized person or agent thereof) moves through an area with designated parking spaces. Thus, for example, a parking officer can be driving around with the unit DU installed on his-her vehicle and set to a mode of reading the license plates of all cars parked in designated spaces. Each time a plate is read, this information is communicated back to the unit ICU and compared to the information obtained from the units M. Should a read vehicle not match information in the ICU, that vehicle would be nearly instantaneously flagged as being improperly or illegally parked. The so-informed parking officer could then stop and issued that vehicle with a parking ticket or violation citation. Moreover, the unit DU would record the flagged vehicle information and could store this information for use in a later legal or quasi-legal proceeding.

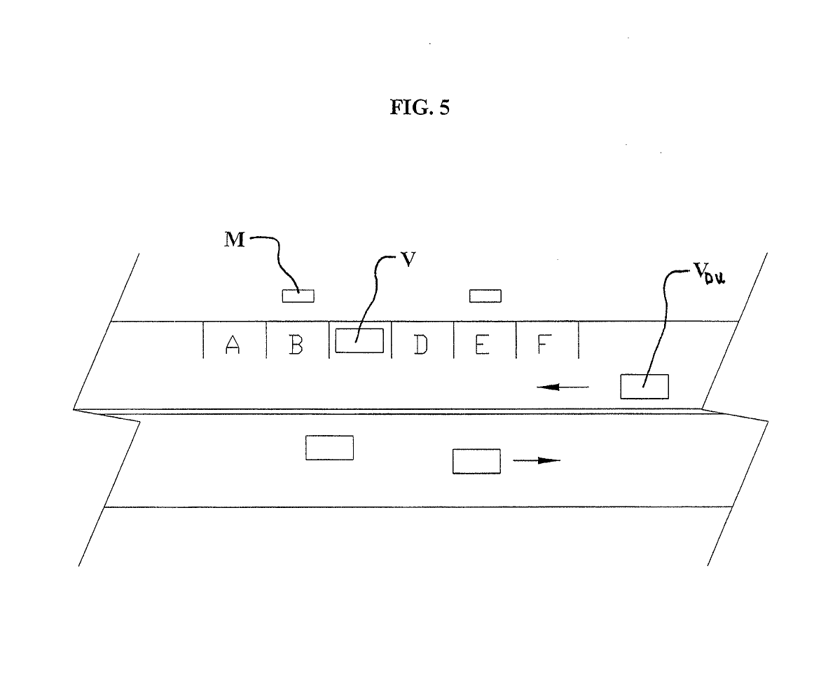

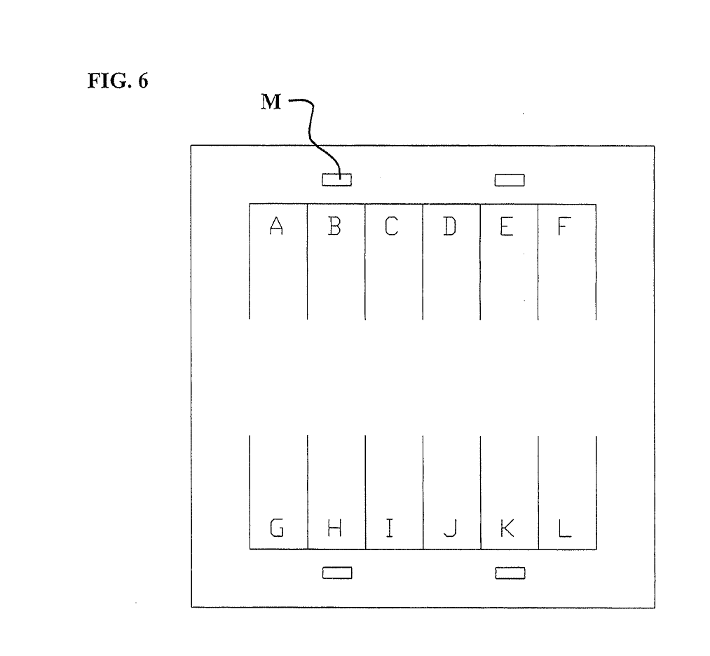

The at least one deployable unit DU is advantageously structured and arranged to read (e.g., using automatic license plate readers) or otherwise obtain in real time, e.g., such as from a transponder (e.g., smart tag or E-zpass@ type) on the vehicle, the vehicle identification information from vehicles located in designated parking locations as the unit DU moves through an area containing the designated parking locations such as a street (see FIG. 5) or parking lot (see FIG. 6).

The at least one deployable unit DU can also be structured and arranged to determine in real time whether a respective vehicle is authorized to be parked in one of the designated parking locations based only the license plate information. As license plate readers are being used more and more by peace officers, among others, the invention takes advantage of their use for more efficient parking enforcement.

The plural information input units M can be parking meters of the type shown in FIG. 2 or alternatively of one or more of the types known in the art such as municipal parking meters.

The information received by the plural information input units M includes optically readable information. Thus, the reader input M2 of the unit M in FIG. 2 can be card reader slot which optically reads information from a card-like member inserted therein. Such card-like members can be an insurance card, a driver's license, or a smart card. Any card containing information about the vehicle (or even the vehicle owner) which can be read optically can be utilized. Alternatively or additionally, the reader M2 can be configured to read or otherwise obtain information in the card or associated therewith by any known electronic method such as a magnetic strip reader.

The vehicle identification information which is read can preferably include license place information or vehicle VIN information. This information is generally more tamper proof or resistant to being obscured. Such information can also be input via a key board M1 by the driver of the vehicle seeking authorization to park in one of the designated locations or via the reader M2 reading an insurance card, for example. It is also contemplated that the vehicle information can be stored on a device or cloud such that a user can transfer or exchange the information from his or her handheld (or wearable) device with the one or more units M. Consumers today are more and more utilizing devices such as smarty phones to make payment electronically and can also present documents such as insurance cards via such devices. Exchanging vehicle information with the one or more units M in a comparable way may become one of the preferred ways in the not so distant future.

The vehicle identification information which is read can also be read automatically if, for example, the license place information or vehicle VIN information is readable by the unit M. This can take place, for example, if the unit M has a reader which can read such information from a vehicle it has a line-of sight to. Equipping the unit M with a license plate reader can be accomplished with conventional technology. In such a system, the unit M can display the vehicle identification information of all of the vehicles in proximity to the meter and ask the driver to select the one from which parking is requested.

In the case of the vehicle having a “smart tag” type device or transponder, the unit M can also be configured to read the vehicle information from the transponder automatically—provided it is located within a readable zone of the unit M. If more than one vehicle is detected (or has its transponder read) by the unit M, the unit M can request that the driver select from a list the correct vehicle for which parking is desired.

FIG. 2 shows a non-limiting embodiment of an information input unit M that utilizes advantageous features. The unit M can resemble a parking meter having a base which statically mounted to a road, ground, or wall surface and can include an electronic display MS for facilitating communication with the persons seeking to park in one of the designated locations. The display MS can also provide a status of the meter M—indicating, among other things, the meter M is operational or not, the status of available designated parking locations, e.g., occupied or unoccupied, the time limit purchased or available, etc. The unit M can also include a first input device M1, e.g., a keyboard, which allows for manual input of vehicle identification. A second input device M2, e.g., a card reader, can be used to allow for automatic input of vehicle identification obtained from the card, e.g., an insurance card, driver's license, or smart card. The device M2 can also function to receive a credit or debit card type card to facilitate payment required for parking. Alternatively, one or more additional payment receiving input devices can be provided which can receive and dispense cash, coins or tokens. The unit M can also include an output device, e.g., a printer, which allows for the printing of a receipt evidencing, among other things, the information input by the driver and/or that the vehicle V is authorized to park in a designated location for a designated time period and showing payment made or required. In embodiments, the unit M can also retain, store or send the vehicle identification information that is inputted or received for use by, e.g., law enforcement. For example, the unit M can send the vehicle identification information to a central location (or cloud) so that a determination can be made as to whether that vehicle is stolen or has outstanding violations. In embodiments, a signal can be sent back to the unit M that instructs or otherwise causes the unit M to disallow that vehicle from parking in one of the designated locations. Even if that vehicle is allowed to park in one of the designated locations, having information about the location of a vehicle having outstanding violations, being stolen or otherwise wanted for investigation, can be an aid to law enforcement. It is also contemplated that the central computer or the law enforcement computer system (or cloud) can be in direct communication with or otherwise alert and/or send information to the units M so that they can determine, at the time when vehicle information is input, whether that vehicle is in violation, stolen, etc. At this point, even if the vehicle is allowed to park in a designated location, law enforcement can be alerted in real time of the vehicle's location. This could greatly aid its use in law enforcement. In other embodiments, the unit M can allow someone to use either of the input devices as a call or alarm button. Thus, if a unit M is not functioning, or if someone is in need of help, or, e.g., they have witnessed or are witnessing a crime, the unit M can serve as an alarm interface by allowing a user to access one of the inputs to send or initiate an alarm and/or communicate with one or more authorities. This user need not be a driver seeking to park his/her vehicle, but can be any person. In one example, a user can depress a special “alarm” or “distress” key on the input (which can also be a stand-alone “emergency” or “Red Cross” button) or even depress keys of a keyboard to spell, e.g., “911” or “SOS” or “HELP” on the keyboard of the unit M, and this can trigger an alarm or send out an alert to law enforcement, or even send a signal to one or more of the deployable units DU, and preferably, the nearest deployable unit DU. The officer or officers having the deployable unit(s) DU can then be instructed or alerted to proceed to the location requesting help and provide assistance as necessary.

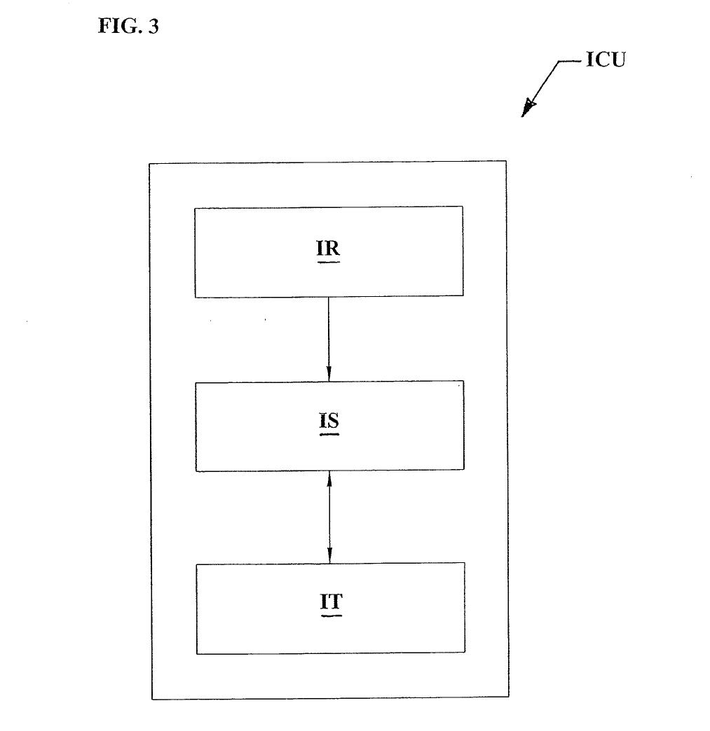

FIG. 3 shows a non-limiting embodiment of information collection unit ICU which collects information from the plural information input units M. The unit ICU includes an Information receiver IR which can receive the vehicle information transmitted or otherwise electronically received from the units M. An information storage/collector/updater IS receives, stores, updates and maintains the information and communicates with an information transmitter IT which can transmit the information or signals indicative thereof to one or more deployable units DU. Each of these devices IR, IS and IT can be implemented with conventional hardware and software modules, but which are configured to implement the information manipulation and transfer of the vehicle information as described herein. In embodiments, the unit ICU can be located in a secure location such as a secure building or even a secure cloud based system or component thereof.

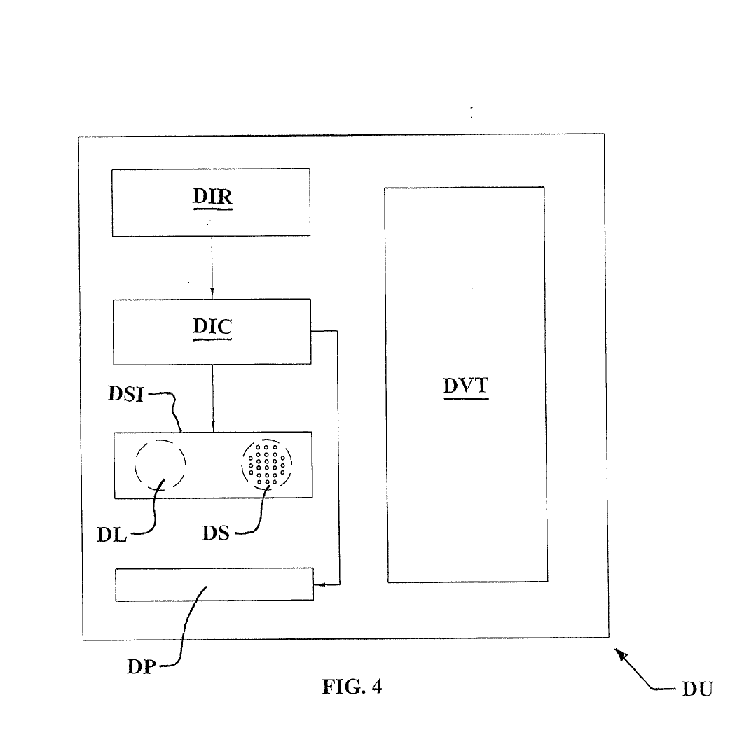

FIG. 4 shows a non-limiting embodiment of at least one deployable unit DU structured and arranged to read or obtain vehicle identification information from vehicles V located in designated parking locations and determine whether a respective vehicle is authorized to be parked in one of the designated parking locations. The one or more units DU can be mounted to a vehicle. Alternatively, it can be a portable device or even be a wearable type device that is capable of obtaining vehicle information while being moved through space. In the case of being mounted to a vehicle, for example, the unit DU can include an information reader DIR which can be a license plate reader or a module coupled to a license plate reader. An information receiver/comparer DIC is utilized to compare the read vehicle information and compare the same to information received from the ICU. A violation/status Indicator/display DSI can be configured to provide an indication based upon signals received from the device DIC. The device DSI can include a number of indications such as a visual indicator display, an indicator light DL and/or an audio speaker DS which can produce a sound indicative of a read vehicle that is in violation. Additionally, the unit DU can include a deployable unit printer DP which can print, among other things, a ticket or violation so that it can be placed on the vehicle V. The information communicated to the printer DP can be communicated from the device DIC. An optional violation input and transmitter DVT can be utilized to transmit information associated with the violation or violations to a central location (or cloud) for storage and possible use in a future legal or quasi-legal proceeding. It is also contemplated that device DVT can be provided with an updated list of vehicles having outstanding violations so that a comparison can be made between this information and the vehicle about to receive a violation. Should such a vehicle be found to already have outstanding violations, a decision can be made to issue another violation and take additional action such a boot the vehicle, tow the vehicle and/or impound the vehicle. As a possible indicator of this latter situation, the device DSI can issue both a light signal on the light DL and an audio signal via the speaker DS to provide an emphasized violation signal or indication.

FIG. 5 shows a non-limiting embodiment of a designated parking area located on a street having opposite sides with opposite flows of traffic. The designated parking locations are labeled A-F with a vehicle V already shown parked in location C. The parking locations A-F can be supervised by one or more meters M of the type shown in FIG. 2. The vehicle V_{DU} shown moving on the street from right to left can be a parking enforcement vehicle which includes the unit DU that can read the license plate of the vehicle in parking location C and can determine automatically, and in real time, if the vehicle V in parking location C is in violation or not. This occurs as follows: if the vehicle V parked in space C is not authorized to do so (which can occur for a number of reasons) at the time when the vehicle V_{DU} passes by, the vehicle V_{DU} will be alerted to this unauthorized status because the unit DU installed thereof will read in real time the vehicle information of the parked vehicle V and determine (based on information collected from the one or more units M) whether the parked vehicle V is authorized to park. Whether the vehicle V is authorized is determined automatically by the unit DU because the unit DU reads the vehicle information of the parked vehicle automatically while the officer vehicle moves. Although not necessary, an audible signal can be triggered in the vehicle V_{DU} as it passes by an authorized vehicle V. This signal can be of low tone, but sufficient to provide an indication that the parked vehicle V has been read and determined to be authorized. Such technology already exists in the case of transponders which are read electronically by toll collection systems. However, when the parked vehicle V is indicated to be unauthorized, the officer is alerted by the unit DU. At that point, the officer can stop in proximity to the vehicle and perform his-her authorized duty which can include, as noted above, the issuance of a violation.

FIG. 6 shows a non-limiting embodiment of a designated parking area located in a parking lot. The designated parking locations are labeled A-L. If a vehicle V is to park in one of the locations, the driver thereof can approach one of the units M and input the vehicle information and optionally one of the parking locations A-L. In this embodiments, each unit M can also function as the officer. That, is, the one or more units M can be located in a position (or placed in communication with vehicle readers also located in the parking lot) and continuously determine whether each vehicle parked in one of the spaces A-L is authorized. This happens because each parked vehicle has its information read on a regular basis and this information is compared to information input by the driver of the vehicle who parked in one of the spaces. If, for example, the driver paid to park the vehicle for two hours, and if more than two hours (plus a possible grace period) has elapsed, the vehicle will be determined to be unauthorized. When this occurs, a violation can be generated. Alternatively (or additionally) an officer located in proximity to the parking lot can be alerted to the unauthorized status and directed to the vehicle in violation. As the officer moves within the parking lot, the unit DU will read each vehicle parked therein and will be able to single out the vehicle that is unauthorized from among other parked vehicles. Again, this can occur via an audible, visual or sensory indicator. At this point, the officer can perform his-her duty by, e.g., issuing a violation and placing it on the vehicle.

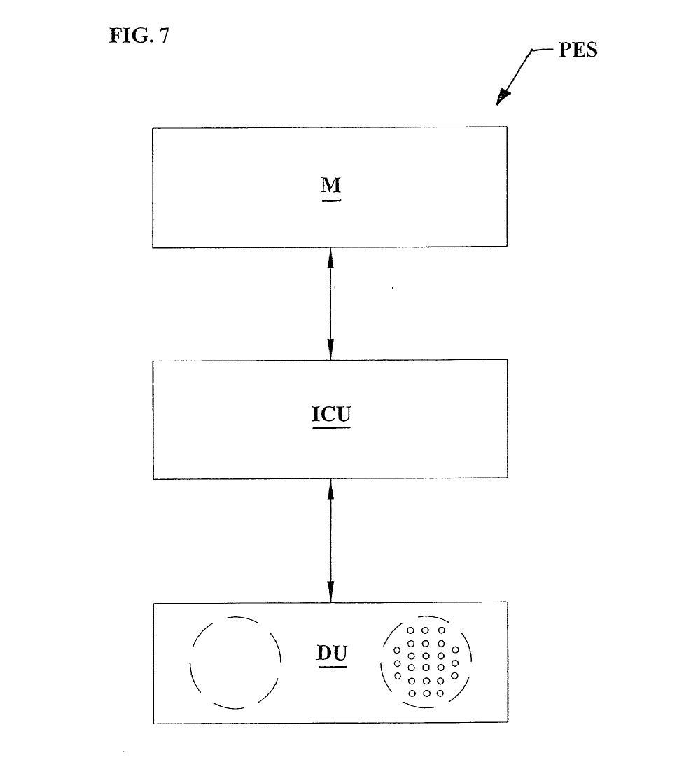

FIG. 7 shows another non-limiting embodiment of a parking enforcement system PES in accordance with the invention. The system PES includes one or more information input units M that are structured and arranged to receive vehicle identification information. These units M can have the form of a parking meter or smart parking meter. The vehicle information can be of any type such as license plate and/or Vehicle Identification Number (VIN) information and/or a transponder. In embodiments, the units M can include features such as shown in FIG. 2. The system PES also includes an information collection unit ICU which collects information from the plural information input units. The arrow from the unit(s) M to unit ICU is intended to show that information from the unit(s) M can be transmitted or otherwise sent electronically to the unit ICU. Moreover, in this embodiment, an arrow from the ICU to the unit M indicates that information or signals can be sent back and forth between these devices. This can occur either directly or via a network and/or cloud. An example of this is when the meter M is informed by the ICU that the vehicle seeking to obtain parking authorization is in violation or has outstanding violations. Using this information, the meter M can reject the request and inform the driver that the vehicle is not and will not be authorized until all outstanding violations are settled. Alternatively, it can merely inform or remind him/her that the vehicle has outstanding violations. Another option is to grant the requested authorization and charge the vehicle a higher rate or higher parking fees. The system also includes at least one deployable unit DU structured and arranged to read or obtain vehicle identification information from vehicles V located in designated parking locations and determine whether a respective vehicle is authorized to be parked in one of the designated parking locations. Since the unit ICU is made of aware of all vehicles in designated parking spaces (within a specified area, e.g., a lot, a city or a district) by the unit(s) M, any vehicle V which has its information read by the unit DU can be compared to those stored or otherwise maintained in the unit ICU (or cloud accessible to the same) to determine if the read vehicle is properly parked. If not, the unit DU can provide an indication, i.e., an audible indication via a speaker DS or a visual indication via a light DL. As discussed herein, this indication can be of many forms especially as future officers may well have wearable devices that may include one or more indicators arranged on or in proximity to the skin so as to provide indicator that is felt rather than merely heard or seen. This alert can allow the person having the unit DU to know that there is an improperly parked vehicle so that he/she can issue a ticket or other indicia of violation. In this embodiment, it is contemplated that the unit DU will be able to read vehicle information automatically or in real time as the officer moves through an area with designated parking spaces. Thus, for example, a parking officer can be driving around with the unit DU installed on his-her vehicle and set to a mode of reading the license plates of all cars parked in designated spaces. Each time a plate is read, this information is communicated back to the unit ICU and compared to the information obtained from the units M (or cloud accessible by the same). Should a read vehicle not match information in the ICU, that vehicle would be nearly instantaneously flagged as being improperly or illegally parked. The parking officer could then stop and issue that vehicle with a parking ticket or violation citation. This can occur in real time and take place either at the vehicle's location, sent remotely, electronically, or even sent via mail. The unit DU can also be configured to record the vehicle, by taking its photograph or digital image, to serve as evidence of the violation. Moreover, the unit DU would record the flagged vehicle information and could store or otherwise upload this information to a cloud or central location for use in a later legal or quasi-legal proceeding.

As in a previous embodiment, the at least one deployable unit DU is advantageously structured and arranged to read (e.g., using automatic license plate readers) or otherwise obtain in real time the vehicle identification information from vehicles located in designated parking locations as the unit DU moves through an area containing the designated parking locations such as a street (see FIG. 5) or parking lot (see FIG. 6).

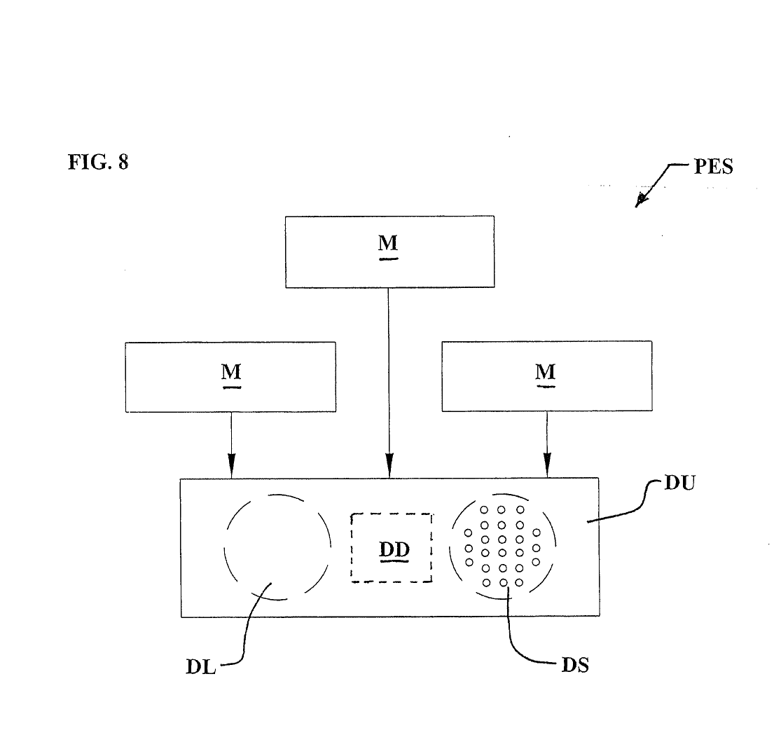

FIG. 8 shows another non-limiting embodiment of a parking enforcement system PES in accordance with the invention. The system PES includes one or more information input units M that are structured and arranged to receive vehicle identification information. These units M can have the form of a parking meter or smart parking meter. The vehicle information can be of any type such as license plate and/or Vehicle Identification Number (VIN) information. In embodiments, the meter M can include features such as shown in FIG. 2. The system PES also includes an information collection unit ICU which collects information from the plural information input units. The unit ICU can in this embodiment be arranged in or as part of the deployable unit DU. In this way, information from the unit(s) M can be transmitted or otherwise sent electronically to the unit ICU of the unit DU. Moreover, in this embodiment, information or signals can be sent back and forth between the DU and the meters M (or via a cloud) or alternatively the DU only receives information from the units M. The system includes at least one deployable unit DU structured and arranged to read or obtain vehicle identification information from vehicles V located in designated parking locations and determine whether a respective vehicle is authorized to be parked in one of the designated parking locations. Since the unit ICU of the unit DU is made of aware of all vehicles in designated parking spaces (within a specified area, e.g., a lot, a city or a district) by the unit(s) M, any vehicle V which has its information read by the unit DU can be compared to those stored or otherwise maintained in the unit ICU to determine if the read vehicle is properly parked. If not, the unit DU can provide an indication, i.e., an audible indication via a speaker DS or a visual indication via a light DL or a display indicator on the electronic display DD. This alert can allow the person having the unit DU to know that there is an improperly parked vehicle so that he/she can issue a ticket or other indicia of violation. In this embodiment, like previous embodiments, it is contemplated that the unit DU will be able to read vehicle information automatically or in real time as the officer moves through an area with designated parking spaces. Thus, for example, a parking officer can be driving around with the unit DU installed on his-her vehicle and set to a mode of reading the license plates of all cars parked in designated spaces. Each time a plate is read, this information is communicated to the unit ICU within the unit DU and compared to the information obtained from the units M. Should a read vehicle not match information in the ICU, that vehicle would be nearly instantaneously flagged as being improperly or illegally parked. The parking officer could then stop and issued that vehicle with a parking ticket or violation citation. Moreover, the unit DU would record the flagged vehicle information and could store this information for use in a later legal or quasi-legal proceeding.

As in a previous embodiment, the at least one deployable unit DU is advantageously structured and arranged to read (e.g., using automatic license plate readers) or otherwise obtain in real time the vehicle identification information from vehicles located in designated parking locations as the unit DU moves through an area containing the designated parking locations such as a street (see FIG. 5) or parking lot (see FIG. 6).

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

In the devices shown in the drawings, the features are designated as follows:
Parking enforcement system PES
Information input unit or meter M
Meter display MS
First Meter Input M1
Second Meter Input M2
Meter printer MP
Vehicle identification information or license plate LP
Information collection unit ICU
Information receiver IR
Information storage/collector/updater IS
Information transmitter IT
Deployable unit DU
Information Reader DIR
Information receiver/comparer DIC
Violation/status Indicator/display DSI
Indicator/display DD
Indicator/light DL
Indicator/speaker DS
Deployable unit printer DP
Violation input and transmitter DVT
Designated parking locations A-L
Vehicle V

1. A parking enforcement system comprising:
plural information input units structured and arranged to receive vehicle identification information;
an information collection unit collecting, storing and/or receiving information from the plural information input units; and
at least one deployable unit structured and arranged to read or obtain vehicle identification information directly from one or more vehicles located in designated parking locations and determine whether a respective vehicle is authorized to be parked in one of the designated parking locations.

2. The system of claim 1, wherein the at least one deployable unit is structured and arranged to read in real time the vehicle identification information from the one or more vehicles located in designated parking locations.

3. The system of claim 1, wherein the at least one deployable unit is structured and arranged to obtain in real time the vehicle identification information from one of more vehicles located in designated parking locations.

4. The system of claim 1, wherein the at least one deployable unit is structured and arranged to determine in real time whether a respective vehicle is authorized to be parked in one of the designated parking locations.

5. The system of claim 1, wherein the plural information input units are parking meters.

6. The system of claim 1, wherein the plural information input units are municipal parking meters.

7. The system of claim 1, wherein the information received by the plural information input units includes optically readable information.

8. The system of claim 1, wherein the vehicle identification information includes license place information, vehicle VIN information and/or vehicle information obtained electronically.

9. The system of claim 1, wherein the vehicle identification information is input by a driver of one of the vehicles wishing to park in one of the designated parking locations.

10. The system of claim 1, wherein the vehicle identification information is input by a driver of one of the vehicles wishing to park in one of the designated parking locations and occurs by inserting at least one readable device into one of the plural information input units.

11. The system of claim 10, wherein the at least one readable device comprises one of:
a credit card;
a smart card;
a driver's license;
an insurance card; and
a device displaying one of the above-noted items.

12. The system of claim 1, wherein the vehicle identification information is electronically received from at least one readable device via one of the plural information input units.

13. The system of claim 1, wherein the vehicle identification information is initially obtained automatically.

14. The system of claim 1, wherein the vehicle identification information is obtained from at least one of the vehicles wirelessly via at least one of the plural information input units.

15. The system of claim 1, wherein the at least one deployable unit comprises a license plate reader which automatically reads the license plate information of vehicles located in designated parking locations, compares the license plate information to the information provided by or residing in the information collection unit, and deteimines whether a respective vehicle is authorized and/or unauthorized to be parked in one of the designated parking locations.

16. The system of claim 1, wherein the at least one deployable unit comprises one of:
a portable or handheld unit that can also dock with a receiving interface on a vehicle; a
portable or handheld unit that can also be recharged when installed in a vehicle; and
a license plate reader which automatically reads the license plate information of vehicles located in designated parking locations and determines in real time whether a respective vehicle is authorized to be parked in one of the designated parking locations.

17. The system of claim 1, wherein the at least one deployable unit comprises a vehicle identification reader which automatically reads vehicle identification information of vehicles located in designated parking locations, determines in real time whether a respective vehicle is authorized to be parked in one of the designated parking locations, and, if not, issues a warning or indication that the vehicle is not authorized to be parked in one of the designated parking locations.

18. The system of claim 1, wherein the at least one deployable unit comprises a vehicle identification reader which automatically reads vehicle identification information of only vehicles located in designated parking locations, determines in real time whether a respective vehicle is authorized to be parked in one of the designated parking locations, and, if not, issues a warning or indication that the vehicle is not authorized to be parked in one of the designated parking locations.

19. The system of claim 18, wherein the at least one deployable unit is one of:
arranged on a vehicle designated to undertake parking enforcement; and
a portable unit adapted to be transported by a parking enforcement officer.

20. The system of claim 19, wherein the information collection unit is arranged in or on a main component also containing the at least one deployable unit.

21. The system of claim 19, wherein the information collection unit is one of:
a cloud; and
a component of a cloud.

22. A parking enforcement system comprising:
plural information input units structured and arranged to receive vehicle identification information and being located in areas proximate to designated parking locations;
an information collection unit collecting information from the plural information input units; and
at least one deployable unit structured and arranged to each of:
receive in real time the collected information;
read or obtain vehicle identification information in real time directly from one or more vehicles located in one or more designated parking locations, and
determine in real time whether a respective vehicle is authorized and/or unauthorized to be parked in one of the designated parking locations.

23. A method of parking enforcement comprising:
receiving via a portable or vehicle mounted device vehicle information from vehicles authorized to be parked in designated parking locations;
after said receiving, reading or obtaining vehicle identification information in real time from vehicles located in designated parking locations, and
one of:
determining in real time whether a respective vehicle is authorized and/or unauthorized to be parked in one of the designated parking locations; and
automatically determining whether a respective vehicle is authorized and/or unauthorized to be parked in one of the designated parking locations.

24. A method of parking enforcement comprising:
receiving vehicle information from all vehicles authorized to be parked in designated parking locations of a predetermined or designated area or zone;
reading or obtaining vehicle identification information, via a transportable and/or vehicle mounted reader unit, directly from vehicles located in the designated parking locations,
producing an audible, visual and/or sensory indication recognizable by a user transporting the transportable reader unit when a respective vehicle is determined to not be authorized to be parked in one of the designated parking locations; and
at least one of:
issuing or causing to issue a ticket or citation to the vehicle determined to not be authorized to be parked in one of the designated parking locations;
disabling or rendering immovable the vehicle determined to not be authorized to be parked in one of the designated parking locations; and
towing away the vehicle determined to not be authorized to be parked in one of the designated parking locations.

25. A parking enforcement system comprising:
plural information input units structured and arranged to receive information usable to identify a vehicle; and
a comparing device comparing vehicle information obtained directly from vehicles located in designated parking locations to the information received by one or more of the plural information input units,
wherein the comparing device is arranged on a portable device or a device mounted to a moving vehicle.

26. A parking enforcement system comprising:
at least one information input unit structured and arranged to receive information usable to identify a vehicle; and
a comparing device comparing in real time vehicle information obtained directly from vehicles located in designated parking locations to the information received by the at least one information input unit.

27. The system of claim 26, wherein the at least one information input unit is one of:
a computer;
a desktop computer;
a smart held-held device; and
a tablet computer.

28. The system of claim 26, further comprising a deployable unit which reads vehicle information and records a location of the read vehicle and a time of recording of the vehicle information.

29. A parking enforcement system comprising:
at least one vehicle information reader structured and arranged to read vehicle information that includes vehicle identification information, vehicle location, and time the vehicle is read; and
a comparing device comparing the vehicle information read at one point in time with the vehicle information read at another and later point in time
wherein the comparing device is arranged on a portable device or a device mounted to a moving vehicle.

30. The system of claim 29, wherein the vehicle information reader and the comparing device are arranged on a deployable unit.

31. A parking enforcement system comprising:
at least one visual information receiving unit structured and arranged to receive in real time visual information associated with at least one of:
a vehicle located in a specific area; and
a parking location located in the specific area;
a determining device determining in real time at least one of:
whether the vehicle located in a specific area is authorized to be in the specific area at a predetermined future point in time;
whether the parking location located in the specific area is occupied by a vehicle when the parking location should no longer be occupied,
wherein the at least one visual information receiving unit is coupled to or communicates with the determining device.

32. The system of claim 31, wherein the at least one visual information receiving unit is a camera.

33. The system of claim 31, wherein the determining device is a portable electronic device comprising a display.

34. The system of claim 31, wherein the determining device is a computer comprising a display.

35. A parking enforcement system comprising:
at least one visual information receiving unit structured and arranged to receive in real time visual information associated with at least one of:
a vehicle located in a specific area; and
a parking location located in the specific area;
a control determining in real time:
whether the vehicle located in a specific area has obtained authorization to be in the specific area; and if not,
whether the parking location located in the specific area is occupied by the unauthorized vehicle for more than a predetermined minimum amount of time such as one minute, and if so,
issuing a notice to requiring payment for parking in the vehicle in the parking location.

36. The system of claim 35, wherein the issuing comprises either providing electronic notification or mailing the notice to an address associated with the vehicle such as is obtained by reading the license plate thereof.

37. The system of claim 35, wherein the issuing comprises automatically issuing either providing electronic notification or mailing the notice to an address associated with the vehicle such as is obtained by reading the license plate thereof.
